(19) United States
(12) Patent Application Publication
(10) Pub. No.: US 2025/0171081 A1
(43) Pub. Date: May 29, 2025

(54) VEHICLE PARKING ASSISTANCE APPARATUS

(71) Applicant: SUBARU CORPORATION, Tokyo (JP)

(72) Inventor: Hiroaki KUDO, Tokyo (JP)

(21) Appl. No.: 18/928,300

(22) Filed: Oct. 28, 2024

(30) Foreign Application Priority Data
Nov. 27, 2023 (JP) 2023-199791

(51) Int. Cl. B62D 15/02; B60W 50/14; G06V 10/80; G06V 20/58

(52) U.S. Cl. CPC B62D 15/027; B60W 50/14; G06V 10/80; G06V 20/586; B60W 2050/146; B60W 2420/403; B60W 2556/35

(57) ABSTRACT

A vehicle parking assistance apparatus is configured to provide parking assistance when parking a vehicle in a parking space. The vehicle parking assistance apparatus includes first and second imagers, a display, and a vehicle controller. The first imager is configured to provide capture a frontward view of the vehicle. The second imager is configured to provide capture a rearward view of the vehicle. The display is configured to provide display at least first imaging data and second imaging data the first imager and the second imager respectively. The vehicle controller is configured to provide calculate parking space data regarding the parking space, using the first imaging data. The vehicle controller is configured to, when detecting shifting of the vehicle to a reverse range, generate synthetic data in which the parking space data is synthesized with the second imaging data, and display the synthetic data on the display.

### CROSS-REFERENCE TO RELATED APPLICATIONS

The present application claims priority from Japanese Patent Application No. 2023-199791 filed on Nov. 27, 2023, the entire contents of which are hereby incorporated by reference.

### BACKGROUND

The disclosure relates to a vehicle parking assistance apparatus.

Japanese Unexamined Patent Application Publication (JP-A) No. 2017-87758 discloses an obstacle detection apparatus to provide a vehicle with parking assistance. The obstacle detection apparatus includes a front camera, a side camera, and a CPU (Central Processing Unit). The front camera captures a frontward view of the vehicle. The side camera captures a sideward view of the vehicle. The CPU calculates obstacle data based on image data acquired by the front camera and the side camera, for example, every 0.1 seconds.

Moreover, a parking space detector detects a parking space present ahead of the vehicle from the image data captured by the front camera, and inputs data regarding the detected parking space in a storage. A sideward obstacle detector analyzes multiple images captured at different timing by the sideward camera, and detects presence of any obstacles in a processing region, or whether the processing region is set to blank.

### SUMMARY

An aspect of the disclosure provides a vehicle parking assistance apparatus configured to provide parking assistance when parking a vehicle in a parking space. The vehicle parking assistance apparatus includes a first imager, a second imager, a display, and a vehicle controller. The first imager is configured to capture a frontward view of the vehicle. The second imager is configured to capture a rearward view of the vehicle. The display is configured to display at least first imaging data acquired from the first imager and second imaging data acquired from the second imager. The vehicle controller is configured to calculate parking space data regarding the parking space, using the first imaging data. The vehicle controller is configured to, when the vehicle controller detects shifting of the vehicle to a reverse range, generate synthetic data in which the parking space data is synthesized with the second imaging data, and display the synthetic data on the display.

An aspect of the disclosure provides a vehicle parking assistance apparatus configured to provide parking assistance when parking a vehicle in a parking space. The vehicle parking assistance apparatus includes a first imager, a second imager, a display, and circuitry. The first imager is configured to capture a frontward view of the vehicle. The second imager is configured to capture a rearward view of the vehicle. The display is configured to display at least first imaging data acquired from the first imager and second imaging data acquired from the second imager. The circuitry is configured to calculate parking space data regarding the parking space, using the first imaging data. The circuitry is configured to, when the circuitry detects shifting of the vehicle to a reverse range, generate synthetic data in which the parking space data is synthesized with the second imaging data, and display the synthetic data on the display.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1 is a block diagram of a vehicle parking assistance apparatus according to an embodiment of the disclosure.

FIG. 2A is a schematic diagram illustrating a parking method using the vehicle parking assistance apparatus according to the embodiment of the disclosure.

FIG. 2B is a schematic diagram illustrating a parking method using the vehicle parking assistance apparatus according to the embodiment of the disclosure.

FIG. 3 is a flowchart of a control method of parking assistance using the vehicle parking assistance apparatus according to the embodiment of the disclosure.

FIG. 4 is a schematic diagram illustrating a display example on the occasion of the parking assistance using the vehicle parking assistance apparatus according to the embodiment of the disclosure.

### DETAILED DESCRIPTION

The obstacle detection apparatus described in JP-A No. 2017-87758 includes multiple cameras, i.e., the front camera and the side camera. The parking space detector uses the image data captured by the front camera, and the sideward obstacle detector uses the image data captured by the side camera. Accordingly, on nighttime travel or on travel in poor conditions of external environment such as the rain, imaging only by the front camera or the side camera causes possibility that desired information is not included in the image data because of poor imaging conditions.

Partition lines of parking spaces are exposed to the wind and the rain for many years, and they sometimes become thinner or partially disappear. -Moreover, when the parking spaces are defined by ropes fixed on the ground covered by gravel, etc., it is difficult to grasp the partition lines. In these cases, there is a concern that it is difficult for the parking space detector to acquire necessary information regarding the parking spaces such as the partition lines based on the image data acquired by the front camera.

Similarly, there is a concern that the sideward obstacle detector fails in analyzing presence of an obstacle only by the image data captured by the side camera. Moreover, when a camera configured to perform highly accurate image analysis is used as the side camera, a new concern arises that it is difficult to reduce manufacturing costs.

It is desirable to provide a vehicle parking assistance apparatus that makes it possible to provide parking assistance by displaying, on a display, synthetic data in which necessary data is compensated using image data acquired from multiple cameras.

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings.

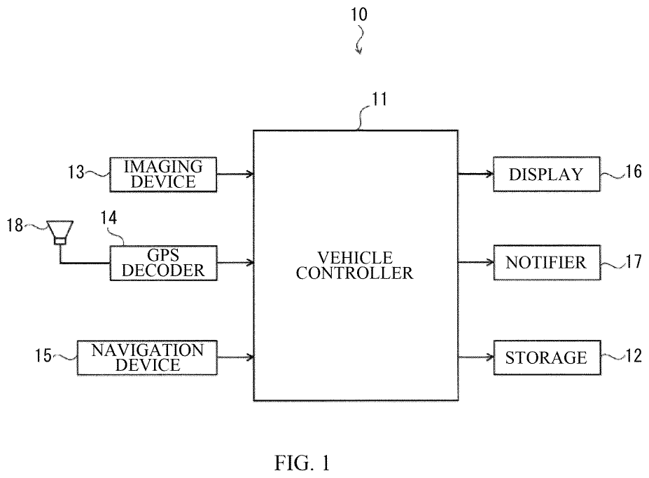

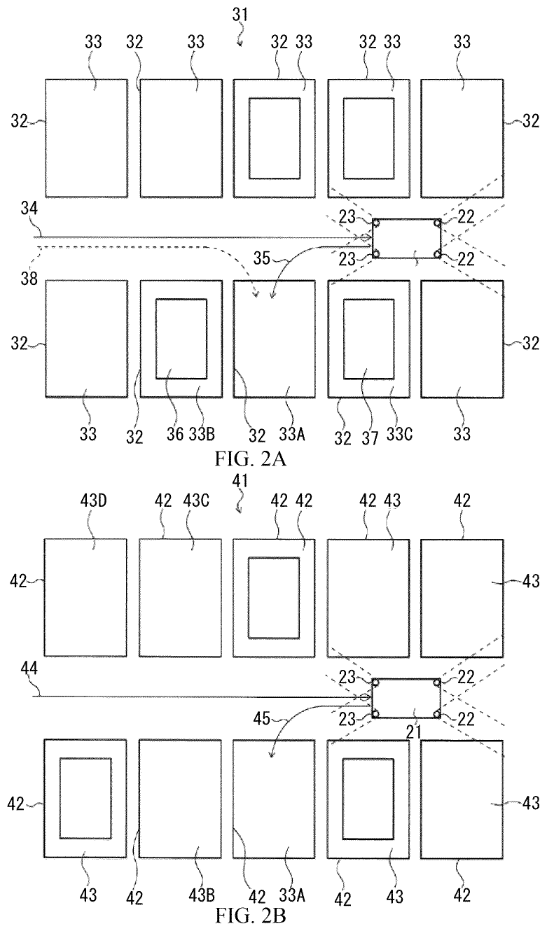

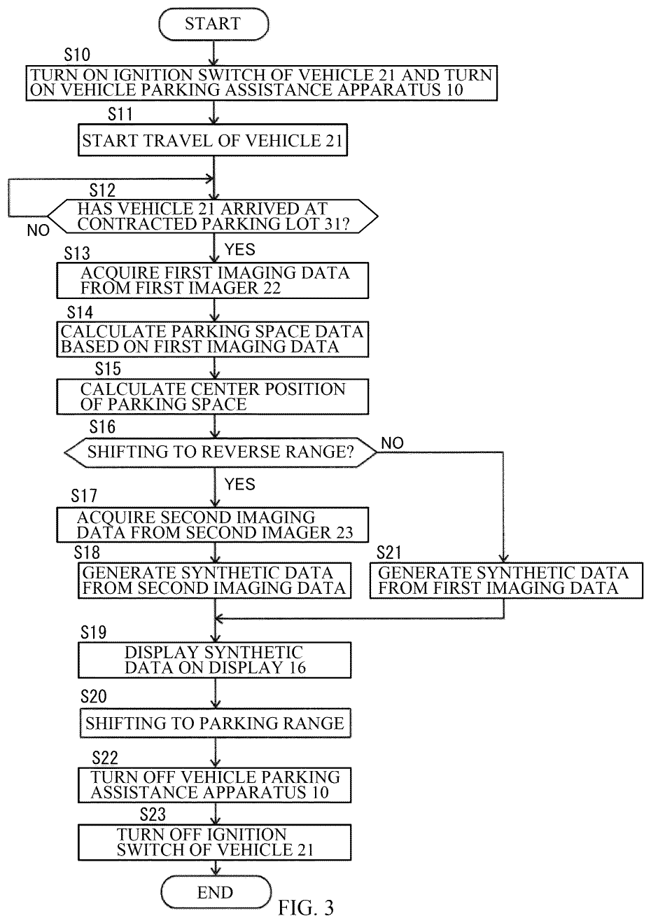

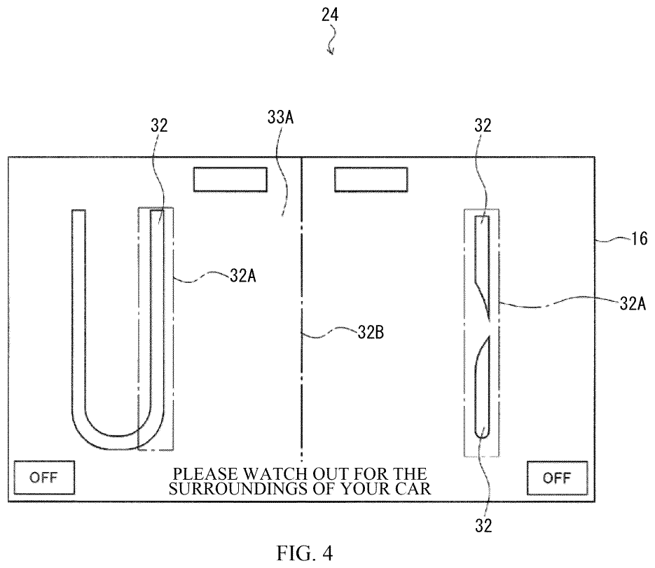

FIG. 1 is a block diagram of a vehicle parking assistance apparatus 10 according to an embodiment. FIG. 2A is a schematic diagram illustrating a parking method using the vehicle parking assistance apparatus 10 of the embodiment, and illustrates a situation of backward parking of a vehicle 21 in a specific parking space 33A. FIG. 2B is a schematic diagram illustrating a parking method using the vehicle parking assistance apparatus 10 of the embodiment, and illustrates a situation of backward parking of the vehicle 21 in an unspecified parking space 43A. FIG. 3 is a flowchart of a control method of parking assistance using the vehicle parking assistance apparatus 10 of the embodiment. FIG. 4 is a schematic diagram illustrating a display example of synthetic data 24 in the control method of the parking assistance using the vehicle parking assistance apparatus 10 of the embodiment.

The vehicle parking assistance apparatus 10 may include, without limitation, a vehicle controller 11, a storage 12, an imaging device 13, a GPS decoder 14, a navigation device 15, a display 16, and a notifier 17. The imaging device 13 may capture images of surroundings of the vehicle 21. Although not illustrated, the vehicle parking assistance apparatus 10 may include, for example, millimeter-wave radar or a near-infrared sensor, detect an obstacle around the vehicle 21, input a detection signal to the vehicle controller 11 for use in the parking assistance described later.

The vehicle controller 11 may include, for example, a CPU, a ROM (Read Only Memory), and a RAM (Random Access Memory). The vehicle controller 11 may include an ECU (Electronic Control Unit) including one or more processors configured to make various kinds of calculation, etc. to control, for example, the vehicle parking assistance apparatus 10 and an unillustrated driving apparatus of the vehicle 21, e.g., an engine.

The storage 12 may include, for example, a nonvolatile memory such as an EEPROM (Electrically Erasable Programmable Read Only Memory). The storage 12 may hold various kinds of data to be involved in controlling the vehicle, and one or more programs executable by the one or more processors. Although details are described later, the storage 12 may hold, for example, parking space data, first imaging data, second imaging data, and the synthetic data 24.

The imaging device 13 may be coupled to the vehicle controller 11 through an in-vehicle network. The imaging device 13 may include, for example, a device configured to capture images of parking spaces 33 and 43, etc. around the vehicle 21 and transmit the captured data to the storage 12. The imaging device 13 may include, for example, a camera module including an image sensor such as a CCD (Charge Coupled Device) or CMOS (Complementary Metal Oxide Semiconductor). As the imaging device 13, for example, a camera module, a dash cam, or the like constituting a driver assistance system may be used. A driver assistance system is a system configured to assist a driver in making driving operations during manual driving of a vehicle or assist in driving operations during automated driving of the vehicle.

In the embodiment, as illustrated in FIGS. 2A and 2B, the imaging device 13 may include a first imager 22 and a second imager 23 each of which includes an image sensor such as a CCD (Charge Coupled Device) or CMOS (Complementary Metal Oxide Semiconductor). The first imager 22 may capture a frontward view of the vehicle 21. The second imager 23 may capture a rearward view of the vehicle 21. First imaging data captured by the first imager 22 and second imaging data captured by the second imager 23 may be transmitted to the vehicle controller 11 and held in the storage 12.

The GPS decoder 14 may decode signals received by a GPS (Global Positioning System) antenna 18 or other GNSS (Global Navigation Satellite System) antennae, and acquire, for example, current positional data regarding the vehicle 21. The current positional data may be transmitted to the vehicle controller 11 and held in the storage 12.

The navigation device 15 is configured to acquire, through an unillustrated vehicle communicator, map data and traffic data. The map data may indicate a map. The traffic data may indicate, for example, traffic congestion or traffic regulation. The navigation device 15 is configured to derive a scheduled travel route indicating a route on which the vehicle 21 is scheduled to travel, based on a place of departure, a destination, and the map data.

As the display 16, for example, a display in an instrument panel in front of a driver's seat, a display disposed above the instrument panel in a central part of the vehicle 21 may be used. The display 16 may be controlled by the vehicle controller 11. On the occasion that the vehicle parking assistance apparatus 10 provides the vehicle 21 with the parking assistance, the synthetic data 24 may be displayed on the display 16.

The notifier 17 may include, for example, a speaker disposed in a cabin of the vehicle 21. On the occasion that the vehicle parking assistance apparatus 10 provides the vehicle 21 with the parking assistance, when the vehicle 21 is at risk of collision with an obstacle such as another vehicle stopped nearby, the notifier 17 may give a notification about the risk.

FIG. 2A illustrates, for example, a contracted parking lot 31 of a condominium. The contracted parking lot 31 may include multiple parking spaces 33 defined by partition lines 32 in white. An owner of the vehicle 21 may contract a parking space 33A of the contracted parking lot 31. Positional data regarding the parking space 33A may be registered in the vehicle 21 in advance. That is, FIG. 2A illustrates a situation in which the vehicle 21 is parked in the parking space 33 A identified in advance.

In this case, a driver of the vehicle 21 may enter the contracted parking lot 31 on forward travel, pass by the specific parking space 33A, as indicated by an arrow 34, and thereafter, park the vehicle 21 in the parking space 33A on backward travel, as indicated by an arrow 35.

At this occasion, for example, the vehicle parking assistance apparatus 10 may acquire the first imaging data from the first imager 22 at timing of arrival of the vehicle 21 at the contracted parking lot 31, using the current positional data regarding the vehicle 21 acquired by the GPS decoder 14, and start to store the first imaging data in the storage 12. In the embodiment, for example, the vehicle controller 11 may acquire the first imaging data regarding the parking space 33A, and parking spaces 33B and 33C on both sides of the parking space 33A, through the first imager 22, and store the first imaging data in the storage 12. FIG. 2A illustrates a situation in which other vehicles 36 and 37 are parked respectively in the parking spaces 33B and 33C.

In the vehicle controller 11, timing of a start of storage of the first imaging data is not limited to the arrival of the vehicle 21 at the contracted parking lot 31. Any design changes may be made, e.g., immediately before the vehicle 21 passes by the parking space 33B or immediately before the arrival of the vehicle 21 at the contracted parking lot 31.

FIG. 2B illustrates, for example, a parking lot 41 of a supermarket. The parking lot 41 may include multiple parking spaces 43 defined by partition lines 42 in white. Because the parking lot 41 is used by an unspecified number of users who come to the supermarket, the owner of the vehicle 21 has to search for a vacant one of the parking spaces 43 and park the vehicle 21. That is, FIG. 2B illustrates a situation in which unspecified vacant parking spaces 43A, 43B, 43C, and 43D are available for parking of the vehicle 21.

In this case, the driver of the vehicle 21 may enter the parking lot 41 on the forward travel, decide to park the vehicle 21 in the parking space 43A, pass by the parking space 43A, as indicated by an arrow 44, and thereafter, park the vehicle 21 in the parking space 43A on the backward travel, as indicated by an arrow 45.

At this occasion, for example, the vehicle parking assistance apparatus 10 may acquire the first imaging data from the first imager 22 at timing of arrival of the vehicle 21 at the parking lot 41, using the current positional data regarding the vehicle 21 acquired by the GPS decoder 14 and the map data acquired by the navigation device 15. At the timing of the arrival of the vehicle 21 at the parking lot 41, the driver of the vehicle 21 has not decided to park the vehicle 21 in the parking space 43A. Accordingly, the vehicle controller 11 may temporarily store, in the storage 12, the imaging data acquired by the first imager 22 in accordance with a direction of advance of the vehicle 21. Thereafter, the driver of the vehicle 21 may decide to park the vehicle 21 in the parking space 43A, stop the vehicle 21, and perform shifting to a reverse range. Thus, the vehicle controller 11 may detect the shifting to the reverse range, keep the first imaging data regarding at least the parking spaces 43A, 43B, and 43C near a position where the vehicle 21 stops and in which the vehicle 21 is going to be highly possibly parked, and store the first imaging data in the storage 12.

Description is given next, with reference to FIG. 3, of a control method of the parking assistance using the vehicle parking assistance apparatus 10. In the following description, as described with reference to FIG. 2A, description is given of the case where the vehicle 21 is parked in the specific parking space 33A on the backward travel.

As illustrated in FIG. 3, in step S10, the driver gets on the vehicle 21 and presses an unillustrated ignition switch, and thereupon, the vehicle 21 is brought to an ignition-on state. By the pressing of the ignition switch, the vehicle parking assistance apparatus 10 of the vehicle 21 is also turned on.

In step S11, the vehicle controller 11 may cause a start-up of an unillustrated vehicle driving mechanism such as an engine, and the driver starts the travel of the vehicle 21 by operating a steering wheel or the like.

In step S12, the vehicle controller 11 may control the GPS decoders 14, acquire the positional data regarding the subject vehicle, and store the positional data in the storage 12. In affirmation (YES) in step S12, when the vehicle controller 11 determines that the vehicle 21 has arrived at the contracted parking lot 31 including the parking space 33A registered in the vehicle 21 in advance, the vehicle controller 11 may cause the flow to proceed to step S13.

In negation (NO) in step S12, when the vehicle controller 11 determines that the vehicle 21 has not arrived at the contracted parking lot 31, the vehicle controller 11 may continuously control the GPS decoder 14, acquire the positional data regarding the subject vehicle, and determine whether the vehicle 21 has arrived at the contracted parking lot 31. In step S12, the vehicle controller 11 may determine, based on the positional data, whether the vehicle 21 has reached within a predetermined range from the contracted parking lot 31 including the parking space 33A.

In step S13, the vehicle controller 11 may activate the first imager 22 and start to capture the frontward view of the vehicle 21. As illustrated in FIG. 2A, the first imager 22 configured to capture the frontward view of the vehicle 21 may be disposed in, for example, a front part of a vehicle body of the vehicle 21. In accordance with the forward travel of the vehicle 21, the first imager 22 may acquire the first imaging data including a capture of the parking space 33A in which the vehicle 21 is to be parked, and surroundings of the parking space 33A, and store the first imaging data in the storage 12.

In step S14, the vehicle controller 11 may calculate the parking space data regarding the parking space 33A based on the first imaging data. In one example, the vehicle controller 11 may extract the partition line 32 of the parking space 33A from the first imaging data, and calculate, for example, a distance from a current position of the vehicle 21 to the partition line 32, and a length of the partition line 32. The vehicle controller 11 may store the distance to the partition line 32 and the length of the partition line 32 in the storage 12.

In step S15, the vehicle controller 11 may calculate a center position of the partition line 32 of the parking space 33A using the distance to the partition line 32 and the length of the partition line 32. The vehicle controller 11 may store the center position in the storage 12.

In step S16, the vehicle controller 11 may detect the shifting of the vehicle 21 from a drive range to the reverse range. In affirmation (YES) in step S16, when the vehicle 21 stops the forward travel, the driver of the vehicle 21 performs the shifting to the reverse range, and the vehicle controller 11 detects the shifting of the vehicle 21 to the reverse range, the vehicle controller 11 may cause the flow to proceed to step S17.

In step S17, the vehicle controller 11 may activate the second imager 23 and starts to capture the rearward view of the vehicle 21. As illustrated in FIG. 2A, the second imager 23 configured to capture the rearward view of the vehicle 21 may be disposed in, for example, a rear part of the vehicle body of the vehicle 21. In accordance with the backward travel of the vehicle 21, the second imager 23 may store, in the storage 12, the second imaging data including the capture of the parking space 33A in which the vehicle 21 is to be parked, and the surroundings of the parking space 33A.

In step S18, using the parking space data mentioned above, the vehicle controller 11 may generate the synthetic data 24 in which, for example, partition lines 32A (see FIG. 4) and a centerline 32B (see FIG. 4) of the partition line 32 are added to the second imaging data. In one example, as illustrated in FIG. 4, the vehicle controller 11 may calculate positions of the partition lines 32A of the parking space 33A using the parking space data calculated based on the first imaging data. Thus, the vehicle controller 11 may generate the synthetic data 24 in which the partition lines 32A calculated based on the first imaging data are synthesized with the partition line 32 of the parking space 33A in the second imaging data. Thereafter, the vehicle controller 11 may store the synthetic data 24 in the storage 12.

In step S19, the vehicle controller 11 may control the display 16 to display the synthetic data 24 on the display 16. As illustrated in FIG. 4, the partition lines 32A may include, for example, two lines in a direction of a lateral width of the vehicle 21 in the parking space 33A. In the synthetic data 24, the partition lines 32A may be displayed in superimposition on the partition line 32 in the second imaging data. Similarly, synthetic display of the centerline 32B of the partition line 32 of the parking space 33A with the second imaging data may be provided between the two partition lines 32A.

In step S20, the driver of the vehicle 21 parks the vehicle 21 in a region defined by the partition line 32 of the parking space 33A while checking the synthetic data 24 displayed on the display 16. After stopping the vehicle 21, the driver performs shifting from the reverse range to a parking range.

In negation (NO) in step S16, as indicated by a dotted arrow 38 in FIG. 2A, when the vehicle 21 enters the contracted parking lot 31 on the forward travel and is parked in the parking space 33A on the forward travel, the vehicle controller 11 may cause the flow to proceed to step S21 without detecting the shifting of the vehicle 21 to the reverse range.

In step S21, using the parking space data mentioned above, the vehicle controller 11 may generate unillustrated synthetic data in which the calculated partition lines 32A and the calculated centerline 32B are synthesized with the first imaging data. As described in step S18, the vehicle controller 11 may calculate the positions of the partition lines 32A of the parking space 33A based on the first imaging data. Thus, the vehicle controller 11 may generate the synthetic data 24 in which the partition lines 32A mentioned above are synthesized with the partition line 32 of the parking space 33A in the first imaging data. The vehicle controller 11 may store the synthetic data 24 in the storage 12. Thereafter, the vehicle controller 11 may cause the flow to proceed to step S19, and perform a parking assistance control described above.

In step S22, the vehicle controller 11 may determine that the vehicle 21 has been parked in the region defined by the partition line 32 of the parking space 33A by detecting the shifting of the vehicle 21 to the parking range. Thus, the vehicle controller 11 may stop the operation of the first imager 22 and the second imager 23, and end the parking assistance by the vehicle parking assistance apparatus 10.

In step S23, the driver of the vehicle 21 presses the ignition switch, and thereupon, the vehicle 21 is brought to an ignition-off state.

In the vehicle parking assistance apparatus 10 of the embodiment, the vehicle controller 11 calculates the parking space data regarding the parking space 33A using the first imaging data acquired from the first imager 22. Thereafter, the vehicle controller 11 generates the synthetic data 24 in which the parking space data is synthetized with the second imaging data acquired from the second imager 23, and displays the synthetic data 24 on the display 16.

In this control method, even when the partition line 32 of the parking space 33A in the second imaging data is unrecognizable by the second imager 23 because of, for example, insufficient illumination at night or poor visibility due to bad weather, the partition lines 32A or the like in the parking space data calculated based on the first imaging data are synthesized with the second imaging data. As a result, it is possible for the driver to make a parking operation of the vehicle 21 while recognizing the parking space 33A by the display 16. It is also possible for the driver to safely park the vehicle 21 backward in the parking space 33A even in the bad condition as mentioned above.

In particular, in recent years, developments of the driver assistance system of the vehicle 21 has brought about enhancement in performance of the imaging device 13 and various sensors configured to recognize the forward view of the vehicle 21. Furthermore, a light illuminating frontward of the vehicle 21 is brighter than a light illuminating rearward of the vehicle 21, which easily makes the first imaging data clearer. As a result, even in the bad condition as mentioned above, it is possible for the first imager 22 to acquire image data that is clearer and higher in image quality than the second imager 23. In the vehicle 21, using the high-performance imaging device 13 as the first imager 22, it is possible to provide the driver with the parking assistance with high accuracy while suppressing manufacturing costs of the vehicle 21.

It is to be noted that the vehicle parking assistance apparatus 10 of the embodiment is not limited to the use in parking the vehicle 21 in the specific parking space 33A regarding which the positional data is registered in the vehicle 21, as illustrated in FIG. 2A. For example, as illustrated in FIG. 2B, the vehicle parking assistance apparatus 10 may be used in parking the vehicle 21 in the unspecified parking space 43A of, for example, the parking lot 41 of the supermarket.

In this case, the vehicle controller 11 may calculate the parking space data regarding the parking spaces 43B, 43C, and 43D around the parking space 43A using the first imaging data acquired from the first imager 22. The vehicle controller 11 may generate the synthetic data 24 described above, at timing when the parking space 43A in which the vehicle 21 is to be parked is identified based on the imaging data by the second imager 23, and display the synthetic data 24 on the display 16. As a result, as to the unspecified parking space 43A, it is possible to produce similar effects to those in the case where the vehicle 21 is parked in the specific parking space 33A as described above with reference to FIG. 2A.

Moreover, in the control method described above in FIG. 3, description is given of a case where, in step S12, the vehicle 21 arrives at the contracted parking lot 31 including the parking space 33A, and thereafter, the vehicle controller 11 may activate the first imager 22, acquire the first imaging data, and store the first imaging data in the storage 12. However, this case is non-limiting.

For example, as described above, when a high-performance camera of the driver assistance system of the vehicle 21 is used as the first imager 22, the first imager 22 may be activated at timing in step S10 when the driver gets on the vehicle 21 and presses the ignition switch. The vehicle controller 11, as the driver assistance system of the vehicle 21, may calculate the parking space data using the image data held in the storage 12.

Although some example embodiments of the disclosure have been described in the foregoing by way of example with reference to the accompanying drawings, the disclosure is by no means limited to the embodiments described above. It should be appreciated that modifications and alterations may be made by persons skilled in the art without departing from the scope as defined by the appended claims. The disclosure is intended to include such modifications and alterations in so far as they fall within the scope of the appended claims or the equivalents thereof.

The vehicle controller 11 illustrated in FIG. 1 is implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of the vehicle controller 11. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of the vehicle controller 11 illustrated in FIG. 1.

1. A vehicle parking assistance apparatus configured to provide parking assistance when parking a vehicle in a parking space, the vehicle parking assistance apparatus comprising:
a first imager configured to capture a frontward view of the vehicle;
a second imager configured to capture a rearward view of the vehicle;
a display configured to display at least first imaging data acquired from the first imager and second imaging data acquired from the second imager; and
a vehicle controller configured to calculate parking space data regarding the parking space, using the first imaging data, wherein
the vehicle controller is configured to, when the vehicle controller detects shifting of the vehicle to a reverse range, generate synthetic data in which the parking space data is synthesized with the second imaging data, and display the synthetic data on the display.

2. The vehicle parking assistance apparatus according to claim 1, wherein
the parking space data includes at least a distance from the vehicle to a partition line that defines the parking space, and a center position of the parking space or a length of the partition line.

3. The vehicle parking assistance apparatus according to claim 1, wherein
the vehicle controller is configured to generate the synthetic data after the vehicle advances and passes by the parking space and the vehicle controller detects the shifting to the reverse range.

4. The vehicle parking assistance apparatus according to claim 1, wherein
the vehicle controller is configured to generate the synthetic data after the vehicle advances and passes by the parking space and the vehicle controller detects the shifting to the reverse range and identifies the parking space based on the second imaging data.

5. The vehicle parking assistance apparatus according to claim 3, further comprising a positional data acquirer configured to acquire positional data regarding the vehicle, wherein
after the vehicle controller determines based on the positional data that the vehicle has reached within a predetermined range from the parking space, the vehicle controller is configured to start to calculate the parking space data based on the first imaging data.

6. The vehicle parking assistance apparatus according to claim 4, further comprising a positional data acquirer configured to acquire positional data regarding the vehicle, wherein
after the vehicle controller determines based on the positional data that the vehicle has reached within a predetermined range from the parking space, the vehicle controller is configured to start to calculate the parking space data based on the first imaging data.

7. A vehicle parking assistance apparatus configured to provide parking assistance when parking a vehicle in a parking space, the vehicle parking assistance apparatus comprising:
a first imager including a first image sensor configured to capture a frontward view of the vehicle;
a second imager including a second image sensor configured to capture a rearward view of the vehicle;
a display configured to display at least first imaging data acquired from the first imager and second imaging data acquired from the second imager; and
circuitry configured to calculate parking space data regarding the parking space, using the first imaging data, wherein
the circuitry is configured to, when the circuitry detects shifting of the vehicle to a reverse range, generate synthetic data in which the parking space data is synthesized with the second imaging data, and display the synthetic data on the display.
